(19) United States
(12) Patent Application Publication
(10) Pub. No.: US 2019/0234107 A1
(43) Pub. Date: Aug. 1, 2019

(54) SYSTEM FOR LOCKING INTERIOR DOOR LATCHES

(71) Applicant: Rustem Latipovich ZLAVDINOV, Almaty (KZ)

(72) Inventor: Rustem Latipovich ZLAVDINOV, Almaty (KZ)

(21) Appl. No.: 16/339,376

(22) PCT Filed: May 30, 2017
(86) PCT No.: PCT/KZ2017/000015

§ 371 Date: Apr. 4, 2019

(30) Foreign Application Priority Data
Nov. 18, 2016 (KZ) 2016/1072.1

(51) Int. Cl. E05B 13/00

(52) U.S. Cl. CPC E05B 13/004; E05Y 2900/132

(57) ABSTRACT

The invention relates to locks in which a sliding latch of an interior door is used as a locking bar. The invention makes it possible to control conventional latches, turning them into reliable, fully-fledged locks which are most suitable for interior doors and which can be easily locked and unlocked with a single touch and which are also capable of allowing a door to be opened from the outside in the event of an emergency. The invention is a system of interacting mechanisms universal to any door latches, which control a rod having a square section characterized in that a mechanism for soft locking a locking latch is disposed therein, the mechanism being activated by a simple touch of a button on the interior handle of the door. In the “locked” position, the system prevents direct forceful loads on the mechanism when both door handles are turned, by allowing the handles to move within the limits of their own return springs. The technical result of the invention is a system which can be universally combined with spring-loaded or magnetic door latches, is simple to install and remove when handles are replaced, and is easy to use, durable, and cheap to manufacture from polymers by die casting or 3D printing.

The invention relates to locks, in which the sliding door latch is also used as a locking bar.

A locking device known in this field is described in RU 2135720 C1 published on Aug. 27, 1999 (E05C1/16). All parts of this locking device are contained within a common metal case, including door handles, with the exception of a specially designed spring-bolt. To install this device, two special crosswise openings in the door panel are required, one of which is located perpendicular to the front side of the door and has a very large diameter barely covered by the handle rosettes.

A disadvantage of this device is that if the appearance of the lock has to be changed, the whole door will have to be replaced, since the mounting seats do not allow for installing a lock of a different system.

Another known cut-in door latch is disclosed in RU 1836532 A3 published on Aug. 23, 1993 (Bulletin 31, E05B55/14). The proposed design utilizes a principle, according to which the latch is locked by the rotating stops, located inside the hollow cases of the interior knobs, which restrict the movement of the sliding tab, and thus, prevent pushing the buttons, which open the door. This device also requires a special key for unlocking the door from outside in case of an emergency. The mounting bores intended such latch can also be used for installing conventional, commonly used door latches and knobs/handles in combination with rosettes or plates.

This invention still has the same common disadvantages, such as complexity of fabrication and installation of the lock, excessive metal consumption, as well as lack of flexibility and softness of operation. Such products do not allow for replacing the knobs or a latch independently of each other. The need to store and use a special key for emergency unlocking is also a disadvantage. However, the main disadvantage is a short service life of the contacting parts due to rigid fixation of the knobs by the rotating stops, which fail as a result of repeatedly applied loads, since a person, who is trying to open the door, instinctively transfers excessive force onto all parts of the lock.

The closest to the proposed invention is the cut-in door lock with additional fixation as disclosed in the specification to SU 1557307 A1 published on Apr. 15, 1990 (Bulletin 14, E05B55/14). The locking bar of this lock is embodied in the form of a generally accepted spring-loaded sliding latch controlled by a standard square rod. The main difference of this lock consists in a pair of door handles mounted on rosettes, wherein the interior handle is configured to rotate in the direction opposite to door opening upon pressing a supplemental axial button, and to be fixated in the vertical position by a tongue between the rosette stops. This fixation also limits the rotation of the square rod, thereby blocking the exterior handle, which also blocks the latch. This lock provides the possibility to replace door handles and latch independently of each other, while the mounting bores can be reused.

A disadvantage is that once locked, this lock (when used in an interior door) cannot be opened from outside without destroying it. Besides, abnormal appearance of the handle in the locked position makes the product look like it is broken. However, rigid fixation of the exterior handle remains to be the main disadvantage. When the lock is in the “locked” position, a person, experiencing an obstacle in the form of a handle that cannot be turned, tries to instinctively overcome such obstacle, which causes an intensive wear of all assemblies and mechanisms of the lock.

The technical objective is to create a simple, universal, and reliable system for using latches controlled by a square rod as locks which do not require the use of additional concurrently installed mechanisms, wherein said system would have polymer material properties (elasticity, wear resistance, low friction coefficient) and would ensure optimization of the production costs as well as expenses for installation prior to use. The system would offer high performance characteristics, such as quiet and soft operation, durability, and compatibility with other types of cut-in spring-loaded or magnetic door latches.

The technical result consists in the invention of a system, which can easily lock door (leaf) latches controlled by a square rod, which allows to fully achieve the above objective.

This technical result is achieved by the fact that the mechanisms of the invented system are contained inside a tetrahedral core-rod representing a main case, which has a round flat spot along the edges in the place of interaction with door latch, and a round stop from the side of the interior door handle. The flat spot enables free turning of the square core-rod inside the latch, which determines the condition of the lock in the “locked” position. The “unlocked” position is enabled by at least one pair of balls interacting with the latch, which are pushed from inside out in the different directions along the diagonal of the square rod within the limits of its external flat spot while being tightly pressed from underneath by the axial spring-loaded pin having a varying cross-section, which passes along the axis of the square core-rod from the side of the interior door handle of the lock. Also, mounted on this end of the tetrahedral rod is a mechanism, which controls the displacement of the pin and fixates the balls pushed out into the required position.

In addition, this system, which easily locks door (leaf) latches, is provided with a pair of door handles. The interior handle has a spring-loaded button installed in the part coaxial with the square core-rod. When pressed, this button enables the movement of the supporting pin through the fixating mechanism located at the end of the tetrahedral rod for pushing out at least one pair of balls interacting with the latch or opening it when the door handles are turned. The exterior handle may have an opening measuring 1-1.5 mm in diameter, which is coaxial with the square rod and is intended for opening the door in case of an emergency by pressing it with any thin needle, such as an unbent end of a paper clip.

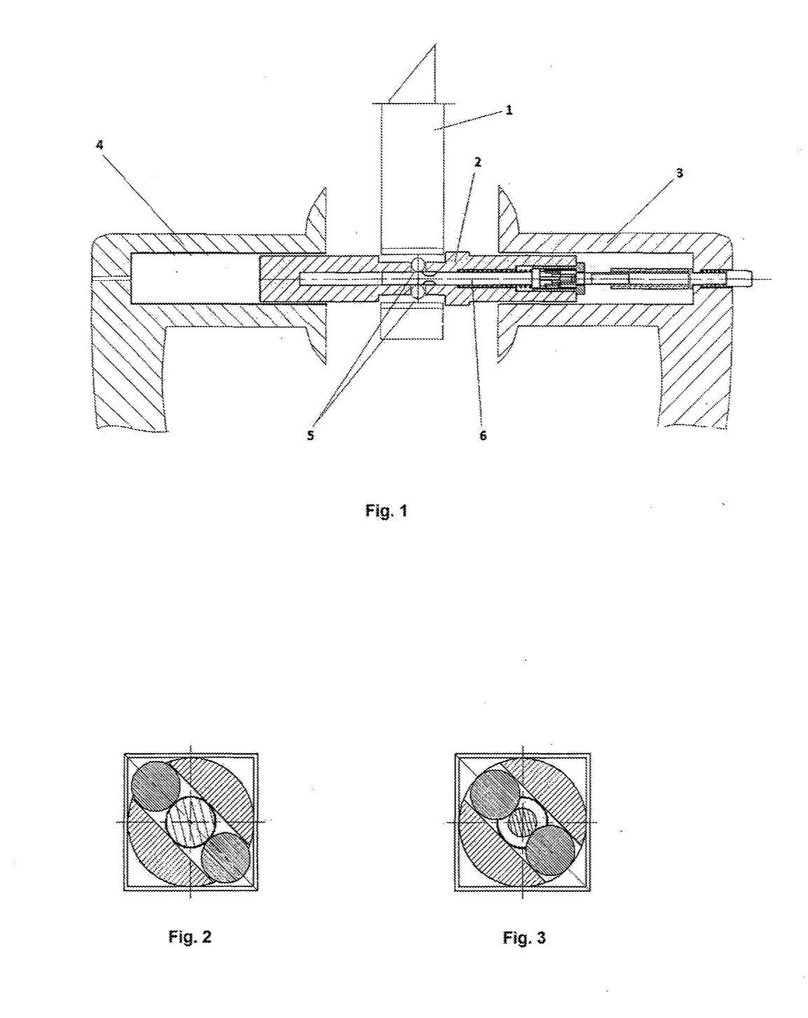

The substance of the invention is explained by the drawings, where in FIG. 1, (1) is a door latch; (2) is a control square core-rod; (3) is an interior door handle with the button; (4) is an exterior door handle; (5) are check balls; and (6) is a supporting pin interacting with the button.

The system for locking door (leaf) latches, which is a combination of interacting mechanisms, has two operating positions: FIG. 2 illustrates the “unlocked” position, in which by turning the control core-rod it is possible to move the bar of the latch; and FIG. 3 illustrates the “locked” position, when the control rod does not interact with the latch.

The case of the mechanism, spring-loaded pin and other elements of the invented system for locking door (leaf) latches can be made of either a metal or plastic material, such as polycaprolactone or polyamide, which significantly simplifies the production process. The door handles would have to be slightly modified by adding holes, which practically does not affect their production.

The invented system for locking door (leaf) latches is compatible with the conventional spring-loaded or magnetic latches of the interior doors and allows controlling them, and thus, turning them into safe, full-fledged locks of the interior doors used in bedrooms, bathrooms, etc., which can be easily locked and unlocked by one touch of a finger. The system also provides a possibility of opening the door from outside in case of an emergency.

What is claimed is:

1. A system for locking door (leaf) latches comprising a control core and one or two handles, wherein said control square core-rod represents a case of an easily blocking control mechanism, and has a round flat spot along the edges in the place of contact with a latch. The operating principle of such mechanism is based on transferring force from turning the handles to displacing a bar of the latch using balls, which are pushed out radially along the diagonal of a square of the section of the control rod within the round flat spot, while being tightly pressed from underneath by the body of a spring-loaded pin. The pin has a varying cross section for pushing said balls in and out, wherein the required displacement of the pin is controlled by a fixating mechanism. The system also features a spring-loaded button located inside the interior handle along the axis of the rod, which transfers reciprocating motion to the spring-loaded pin through the fixating mechanism, while the exterior handle may have a narrow opening along the axis of the rod for unlocking the mechanism and opening the door leaf from outside in case of an emergency by simply pressing with a thin needle.
